(19) United States
(12) Patent Application Publication
(10) Pub. No.: US 2009/0202958 A1
(43) Pub. Date: Aug. 13, 2009

(54) Occlusion indicator & process

(76) Inventor: Eric J. Knutson, Granite Bay, CA (US)

Correspondence Address: Eric J. Knutson, 5815 Granite Hills Drive, Granite Bay, CA, 95746, US

(21) Appl. No.: 12/069,599

(22) Filed: Feb. 11, 2008

(51) Int. Cl. A61C 9/00

(52) U.S. Cl. 433/71

(57) ABSTRACT

Processes for marking contacts of teeth, utilizing a soft polymer sheet. The sheet clearly marks contacts to facilitate disclosure and adjustment of interferences. An arch (10) sheet is provided to mark and adjust an entire arch of teeth. An adhesive (16) is provided to affix the sheet to the surfaces of the teeth.

### BACKGROUND

1. Field of Invention

This invention relates to dental treatment, specifically to indicating or disclosing the occlusion of teeth.

2. Description of Prior Art

Contacts are areas of the teeth that touch with pressure. Occlusal contacts are those which contact teeth of an opposing dental arch. For this discussion, the terms “tooth” and “teeth” may be used interchangeably and will include restorations and prostheses such as crowns, bridges, partial crowns, inlays, onlays, removable partial dentures, dental appliances, or any combination thereof.

The existing pattern of contact location and pressures of occlusal contacts in a mouth are known collectively as the “occlusion” of that mouth. The occlusion is commonly marked such that a dental practitioner can assess the position and appearance of the marks. The assessment of the marks is made to estimate whether or not the contacts are within an appropriate range of position and pressures.

Contacts which have too much pressure, as well as contacts which are located outside the normal range of position, are both known as interferences. When interferences are present in the dentition, it is preferable for the interference to be corrected to within a normal range of pressure as soon as possible. Left unadjusted, interferences frequently cause excessive wear or fracture of a tooth or prosthesis, can damage the periodontal ligament and alveolar bone, can cause pain, and can begin a chain of events leading to infection and tooth loss.

Dentists have utilized various means and materials to locate and disclose occlusal contacts. A first disclosing material is wax. A wax sheet is placed between contacting surfaces and the pressure deforms or perforates the wax to locate the contacts. The wax is not affixed to the teeth, so it may be displaced after marking.

A second disclosing material is dental impression material. Impression material is placed between contacting surfaces and contact pressure deforms or perforates the impression material, thereby locating the contacts. The impression material may or may not harden during use. Impression material tends to form large, thick lumps of material that are not affixed to the teeth. The material may be displaced after marking, and can block access for making adjustments to inferences through the material.

A third such material is ink film, including ink paper. An ink film is placed between contacting surfaces and the contact pressure transfers the ink to the teeth to disclose the contacts. However as the ink film is pressed about the teeth, the ink also tends to mark the teeth in areas where no contact is located, thereby producing false-positive marks.

A fourth class of such materials is comprised of at least partly opaque media, including inks, paints, or pastes. The media is applied to the teeth by brushing or spraying. Contact pressure removes a portion of the media, thereby disclosing the contact location. These media can smear or wipe off readily to form a false-positive mark.

A fifth such material comprises an array of electronic pressure sensors configured as a dental arch. The pattern and relative pressures of occlusion are recorded when a patient occludes on the sensors. To adjust an interference displayed on a monitor, the sensor must be removed from the mouth prior to the adjustment.

A sixth such material is polytetrafluoroethylene, called PTFE. In one embodiment, rectangular strips are cut from a spool and adhered to a portion of a dental arch for marking occlusal contacts. However, the straight strip tends to wrinkle and distort if forcefully adapted to follow the curvature of an arch. The process specifies that the strip is affixed to the teeth with adhesive to stabilize the position of the strip.

In another embodiment, a full-arch PTFE sheet is used for recording the occlusal contacts. The sheet is continuous across the lingual-central area, connecting the distal-most portions of the right and left side of the arch. For this discussion the term “lingual” is synonymous with the term “palatal.” The central connection provides stability of the sheet for the handling required in the process. In the process, the arch sheet is inserted between occluding dental arches to mark the occlusion on the sheet, and removed from the mouth to assess and record the occlusion. The sheet is not adapted to the teeth of the arch, the sheet is not adhered to the arch, nor does the sheet remain on the teeth when the contact marks are observed by the practitioner. The arch sheet would resist simultaneous adaptation to the teeth on the right and left sides because of the central lingual connection.

In another embodiment, PTFE is embedded in a nightguard. When the nightguard is worn during sleep and the patient grinds their teeth, the PTFE tends to change appearance from white to translucent over the area of the grinding. This demonstrates only that the teeth have been grinding, since individual contact markings are entirely obscured by the repetitive jaw movement. Therefore occlusal contacts are not marked by the nightguard.

The above contact disclosing devices and processes suffer from a number of disadvantages:
(a) marks formed are unclear
(b) pressure differences between marks are difficult to interpret
(c) contact marking systems form false-positive marks
(d) some systems require removal of marking media before an interference may be adjusted
(e) resists adaptation to the teeth around a curved arch
(f) most marking media provide little if any information about contact excursions

### SUMMARY OF THE INVENTION

The present invention is directed to an apparatus and method for disclosing contacts utilizing soft polymer sheeting.

The apparatus includes a soft polymer sheet, such as a sheet of PTFE, that is configured so as to be conveniently adaptable to a dental arch. The sheet may be provided as full-arch U-shaped sheets that are proportioned to cover a typical dental arch, or as partial-arch sheets that cover only a portion of a dental arch. The sheet is relieved in the lingual area to further facilitate adaptation to the teeth.

Another aspect of the invention provides processes of marking contacts by adapting a U-shaped soft polymer sheet to the teeth, occluding the teeth on the sheet, and observing the marks with the sheet on the teeth. As such, the contacts may be disclosed, and any contacts assessed to be interferences may be directly adjusted, such as by grinding on the teeth with a drill bit through the sheet without removing the sheet from the teeth. The sheet may be affixed to the teeth by coating the teeth with an adhesive prior to adapting the sheet.

A first process for locating occlusal contacts comprises the steps of adapting a soft polymer sheet to the teeth, contacting the teeth to form marks in the soft polymer sheet, and observing the marks with the sheet on the teeth. After marking, the teeth may be adjusted through the sheet at the marks.

A second process for locating occlusal contacts comprising the steps of applying adhesive onto the teeth to form coated teeth, affixing a U-shaped soft polymer sheet to the coated teeth, and contacting the teeth to form marks in the soft polymer sheet. After marking, the teeth may be adjusted through the sheet at the marks.

### OBJECTS AND ADVANTAGES

Accordingly, several objects and advantages of my invention and process are:
(a) to provide a contact marking medium that forms marks of high clarity
(b) to provide a contact disclosing process that conveys information about the relative pressure differences between contact marks
(c) reduce the incidence of marks made in the disclosing material that are not correlated with the location of a contact
(d) to provide a contact disclosing process that permits practitioners to observe or adjust the occlusion while the disclosing media is on the teeth
(e) to provide a disclosing material that permits the practitioner to be able to determine the direction of the contact excursion as the teeth occluded and discluded
(f) to provide a disclosing material and process that is economical.

Further objects and advantages are to provide a disclosing material that is convenient to apply to the curvature of a dental arch.

Still further objects and advantages will become apparent from a consideration of the ensuing description and drawings.

### DRAWING FIGURES

FIG. 1 is a top view of a full-arch U-shaped soft polymer sheet for marking occlusal contacts

FIG. 2 is a perspective view of a full-arch U-shaped soft polymer sheet for marking occlusal contacts releasably affixed to a holder.

FIG. 3 is a perspective view showing the application of a temporary adhesive to the teeth with gauze prior to application of a soft polymer sheet.

FIG. 4 is a perspective view showing a U-shaped soft polymer sheet covering the teeth and the teeth occluded on the sheet to form contact marks.

FIG. 5 is a perspective view showing adjusting the teeth through a U-shaped soft polymer sheet at the contact marks.

FIG. 6 is a top view of a partial U-shaped soft polymer sheet for marking occlusal contacts.

### REFERENCE NUMERALS IN DRAWINGS

10 arch
12 slits
14 holder
16 adhesive
18 gauze
20 roll
22 mark
24 drill
26 quadrant

### DESCRIPTION

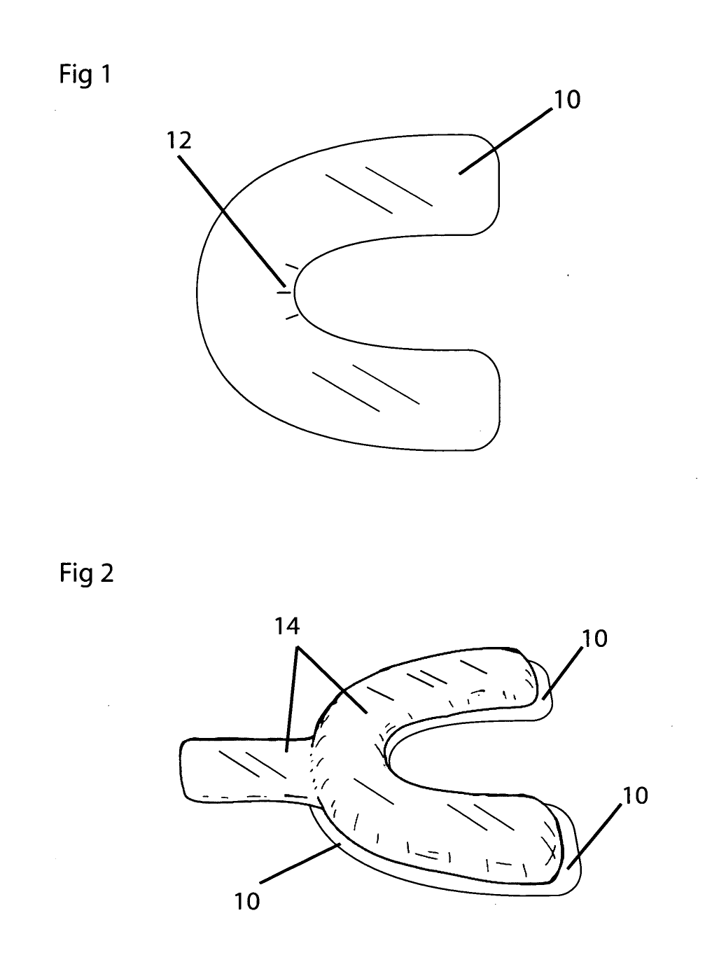

### FIGS. 1 to 6

According to one aspect, the invention provides a process for marking the contacting areas of the teeth, comprising the steps of adapting a soft polymer sheet to the teeth, applying contact pressure to the teeth to form contact marks, and observing the marks while the sheet remains on the teeth.

According to another aspect, the invention provides a soft polymer sheet for marking contacts in the process of the invention, a typical embodiment of which is shown in FIG. 1. A soft polymer sheet is configured as a U-shaped arch, arch 10, such that the occlusal surfaces of a dental arch may be substantially covered for marking. The lingual area of arch 10 is cut away to eliminate a bilateral connection between the right and left sides that would inhibit the adaptation of arch 10 to the teeth.

It is preferred that the soft polymer sheet is comprised of unsintered, unstretched, 0.3 d to 1.6 d polytetrafluoroethylene, called PTFE, and especially 0.4-1.0 d PTFE. However, stretched PTFE membrane is also effective, and is highly adaptable due to multidirectional stretchability. Other soft polymer materials may be effective as well.

It is preferred that arches comprised of unstretched PTFE are oriented such that the PTFE stretches laterally rather than anterior-posteriorly. Such lateral stretching facilitates close adaptation of the anterior-lingual portion of arch 10 to the lingual surfaces of the anterior teeth. To further facilitate adaptation of arch 10 to the teeth, it is preferred that a multiplicity of relieving radial slits, slits 12, are located along, or near to, the lingual edge, especially in the anterior portion. During adaptation of arch 10 to the teeth, slits 12 may expand to reduce tenting of the sheet 10 material.

To facilitate inserting arch 10 into the mouth, arch 10 is releasably affixed to a holder, holder 14, shown in FIG. 2. It is preferred that holder 14 is comprised of a flexible tray similar to a foam fluoride tray. However, holder 14 may be comprised of a full-arch articulating film forceps or clamp holder, such as BK 130 (Bausch), Hanel Double Fork occlusal foil holder (Coltene), backing paper or cardstock, an impression tray loaded with damp cotton, and so on. Arch 10 may be temporarily adhered to holder 14 as a means to carry arch 10 into the mouth and adapt it to the teeth. Holder 14 is removed from arch 10 and from the mouth prior to occluding the teeth to mark the contacts.

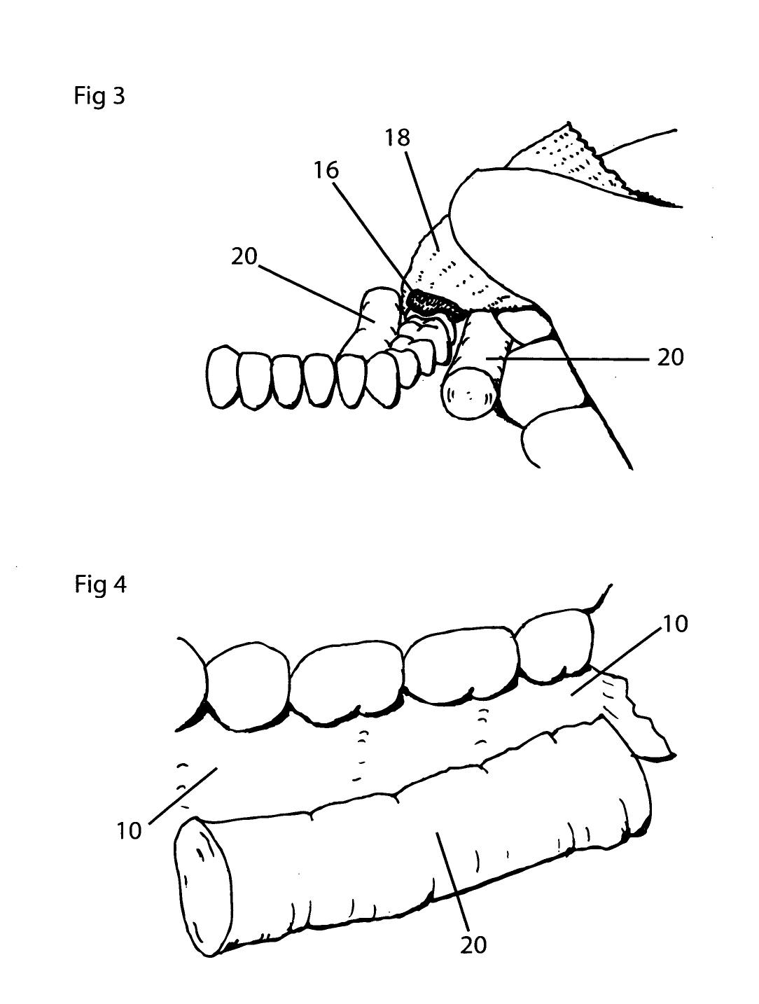

To facilitate marking and adjusting interferences, it is preferred that the soft polymer sheets of the invention are stabilized by an adhesive coating on the teeth. FIG. 3 shows applying a temporary adhesive, adhesive 16, such as Tapetrix Adhesive (Cognident LLC), to the teeth prior to application of a soft polymer sheet, utilizing a gauze square, gauze 18. However, adhesive 16 may be applied by other means such as with a swab, a foam fluoride tray coated with adhesive 16, a finger, and so on. Rolls 20 are placed for isolation.

Arch 10 is applied to the teeth, such as by releasably connecting a holder 14 to arch 10, inserting holder 14 with connected arch 10 into the mouth, and pressing against holder 14 so that holder 14 presses arch 10 onto the teeth. After arch 10 is applied to the teeth, the teeth are occluded on arch 10 to form contact marks, as shown in FIG. 4. Roll 20 is provided for isolation.

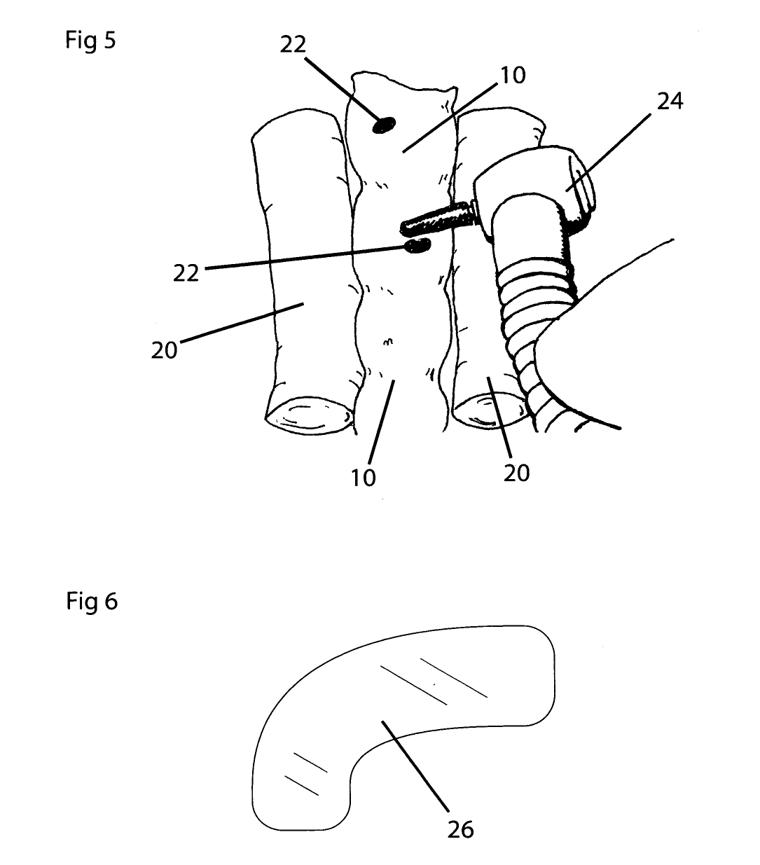

As the teeth occlude on arch 10, contact marks, marks 22, are formed, as shown in FIG. 5. The teeth are adjusted through arch 10 at marks 22, such as with a high-speed handpiece, drill 24, with a diamond drill bit. Carbide bits are not recommended due to their tendency to spool the sheet. Adjustments may also be made with a stone or with a slowspeed handpiece.

The marks 22 shown in FIG. 5 have been formed by pressure deformation of the soft polymer sheet by the teeth contacts. The thin sheet deforms readily under pressure, thereby minimizing proprioceptive disturbance of the occlusion. With the soft polymer sheet of the invention, false positive marks are rare since the sheet does not mark unless pressure is applied. False-positive marks are substantially reduced. In contrast, false-positive marks are common with traditional marking techniques. False-positive marks generate significant confusion as to the location of interferences or the adequacy of the occlusion.

The appearance of each mark 22 provides information about the contact pressure with which it was formed. A light pressure contact will deform the sheet to a partial thickness, and will be visible as a slightly darkened indentation into the sheet. A heavy contact will deform the sheet virtually through the entire thickness of the sheet, and will be visible as a darker and deeper indentation into the sheet. The size of the mark 22 also conveys information, as a lighter mark 22 of a given size requires less pressure to form than a darker mark 22 the same size.

As such, a practitioner observing marks 22 is generally able to differentiate between relative contact pressures based on the shading of the marks 22. In addition, marks 22 also record significant information about the direction of the occlusal excursions, as the occluding teeth drag in and out of the contact deformation when occluding and discluding, further deforming the sheet.

FIG. 6 shows a partial U-shaped soft polymer sheet, quadrant 26, for marking occlusal contacts. Quadrants 26 may be supplied in a stack, such as with separating sheets placed between each quadrant 26. The configuration of quadrant 26 facilitates covering the curvature of an arch without excessive wrinkles or distortion.

From the description above, a number of advantages of the soft polymer sheet become evident:
(a) the sheet can form clear readable marks
(b) the sheet does not form false-positive marks
(c) the relative pressures of the marks can be interpreted
(d) interferences may be adjusted without removing the sheet
(e) contact excursion routes can often be seen
(f) the sheet may be applied to a curved arch without excessive wrinkling or distortion.

### Operation—FIGS. 1-6

By using the soft polymer sheet of the invention, it is now possible, surprisingly, to clearly mark the contacts and interferences of teeth and prostheses. The process offers the advantage that the dental practitioner can now disclose contacts with clear marks, and without the confusion of false-positive marks. Further, a practitioner observing the marks is generally able to differentiate between relative contact pressures based on the shading and size of the mark.

According to one aspect, the invention provides a soft polymer sheet for marking contacts in the process of the invention. According to another aspect, the invention provides processes for marking the contacting areas of the teeth.

### EXAMPLE 1

To mark contacts on a full arch of teeth, an arch 10 is selected, as in FIG. 1, wherein arch 10 is comprised of unstretched PTFE. A first foam fluoride tray is selected to function as holder 14. The upper lip of holder 14 is coated with Vaseline, KY Jelly, glycerin, or such. The coated lip of holder 14 is touched to arch 10 to lightly adhere arch 10 to holder 14, as shown in FIG. 2.

The inner surface of a second foam fluoride tray is coated with adhesive 16 to form a coated tray. The operator isolates the field, such as by placing rolls 20 in the vestibules, and dries all the teeth in the arch. The coated second fluoride tray is inserted over the arch. The coated tray is pressed onto the surface of the teeth to transfer adhesive 16 from the tray to the teeth to form coated teeth. The patient occludes against the coated tray to further coat the teeth with adhesive 16. The coated tray with adhesive 16 is removed from the mouth.

Holder 14 with arch 10 adhered is pressed onto the adhesive 16 coated teeth to affix arch 10 to the teeth. The patient occludes lightly against holder 14 to adapt arch 10 to the teeth. Holder 14 is removed from the mouth, leaving arch 10 adhered to the teeth. Arch 10 is further adapted to the surfaces of the teeth, such as by pressing with a roll 20 held in hemostats. The patient occludes and grinds the teeth to mark arch 10, as shown in FIG. 4.

The patient discludes, revealing marks 22 in arch 10. The operator notes the pattern, size, and shading of marks 22 to assess the occlusion. Any interfering contacts noted are adjusted, such as by grinding with a diamond bur through arch 10 at marks 22, as shown in FIG. 5. Arch 10 is removed from the teeth and discarded, and adhesive 16 is wiped from the teeth.

### EXAMPLE 2

To mark contacts on a full arch of teeth, an arch 10 is selected, as in FIG. 1, wherein arch 10 is comprised of stretched PTFE membrane. A foam fluoride tray is selected to function as holder 14. The upper lip of holder 14 is coated with water or glycerin. The coated lip of holder 14 is touched to arch 10 to lightly adhere arch 10 to holder 14, as shown in FIG. 2.

Holder 14 with arch 10 adhered is pressed onto the teeth to adapt arch 10 to the teeth. The patient occludes lightly to further adapt arch 10. Holder 14 is removed from the mouth, leaving arch 10 clinging to the teeth by saliva surface tension. Arch 10 is further adapted to the surfaces of the teeth, such as by pressing with a roll 20 held in hemostats. The patient occludes and grinds the teeth to mark arch 10, as shown in FIG. 4.

The patient discludes, revealing marks 22 in arch 10. The operator notes the pattern, size, and shading of marks 22 to assess the occlusion. Any interfering contacts noted are adjusted, such as by grinding with a diamond bur through arch 10 at marks 22, as shown in FIG. 5. Arch 10 is removed from the teeth and discarded.

### EXAMPLE 3

To mark and adjust the occlusion in a quadrant, a quadrant is isolated, and adhesive 16 is applied to the teeth, such as with gauze 18, as shown in FIG. 3. A quadrant 26, as shown in FIG. 6, is applied to the teeth and adapted to the teeth, such as by pressing with a roll 20 held in hemostats.

The patient occludes and grinds the teeth to mark quadrant 26. The patient discludes, thereby revealing marks 22 in quadrant 26. The operator notes the pattern, size, and shading of marks 22 to assess the occlusion. Any interfering contacts noted are adjusted, such as by grinding with a diamond bur through quadrant 26 at marks 22. Quadrant 26 is removed from the teeth and discarded, and adhesive 16 is wiped from the teeth.

### SUMMARY, RAMIFICATIONS AND SCOPE

Accordingly, the reader will see that the soft polymer sheet of this invention is permits a dental practitioner to efficiently identify and analyze occlusal contacts and interferences. The soft polymer sheet has the additional advantage of minimizing the number of false-positive contact marks. Furthermore, it also permits direct adjustment of interferences through the sheet on the teeth.

Although the above descriptions contain many specificities, these should not be construed as limiting the scope of the invention and process, but as merely providing illustrations of some of the presently preferred embodiments of this invention. For example, a stretched PTFE membrane may be applied to adhesive 16 coated teeth.

As a second example, other configurations of the soft polymer sheet may be utilized in the processes of the invention, such as applying a rectangular strip of stretched PTFE membrane to the teeth without adhesive 16.

Thus the scope of the invention should be determined by the appended claims and their legal equivalents, rather than by the examples given.

1. A U-shaped soft polymer sheet for adapting to the teeth for marking occlusal contacts by deformation of said sheet from occlusal contact pressure.

2. The process of claim 1 wherein said U-shaped sheet is a partial U-shape.

3. The process of claim 1 wherein said U-shaped sheet is comprised of PTFE.

4. The process of claim 3 wherein said U-shaped sheet is comprised of stretched PTFE membrane.

5. A process for marking occlusal contacts comprising the steps of adapting a soft polymer sheet to the teeth, applying contact pressure to said sheet to form contact marks, and observing said marks while said sheet remains adapted to the teeth.

6. The process of claim 5 wherein said occlusal contacts are adjusted though said sheet.

7. The process of claim 5 wherein said sheet is at least partially U-shaped.

8. The process of claim 7 wherein said sheet is adhered to the teeth.

9. The process of claim 5 wherein said sheet is comprised of PTFE.

10. The process of claim 9 wherein said sheet is comprised of stretched PTFE membrane.

11. A process for marking contacts comprising the steps of coating teeth with adhesive to form coated teeth, affixing a U-shaped soft polymer sheet to said coated teeth, and applying contact pressure to said sheet to form a contact mark.

12. The process of claim 11 wherein said occlusal contacts are adjusted though said U-shaped sheet.

13. The process of claim 11 wherein said U-shaped sheet is a partial U-shape.

14. The process of claim 11 wherein said U-shaped sheet is comprised of PTFE.

15. The process of claim 14 wherein said U-shaped sheet is comprised of stretched PTFE membrane.
